(19) United States
(12) Patent Application Publication
(10) Pub. No.: US 2006/0170124 A1
(43) Pub. Date: Aug. 3, 2006

(54) Method of manufacturing an orthodontic bracket

(76) Inventor: Rolf Forster, Pforzheim (DE)

Correspondence Address: Orum & Roth LLC;Ste 1616, 53 W Jackson Blvd, Chicago, IL, 60604, US

(21) Appl. No.: 11/333,740

(22) Filed: Jan. 17, 2006

Related U.S. Application Data
(63) Continuation of application No. 10/695,694, filed on Oct. 29, 2003, now abandoned.

(30) Foreign Application Priority Data
Oct. 29, 2002 (DE) 102 50 983.2

(51) Int. Cl. A61C 13/00

(52) U.S. Cl. 264/16

(57) ABSTRACT

Method of Manufacturing an orthodontic appliance appliance, especially a bracket or a buccal tube that is made in full or in part, of a plastic material which exhibits a water absorption capacity and in which is deposited a water-soluble additive, especial an antibacterial additive that restrains the formation of plaque.

### CROSS REFERENCE TO RELATED APPLICATIONS

This application is a Continuation of U.S. application Ser. No. 10/695,694 that was filed on 29 Oct. 2003 and entitled Orthodontic Appliance, especially an orthodontic bracket that claimed priority to German application number 102 50 983.2 filed on 29 Oct. 2002 with the German Patent-Office.

### BACKGROUND OF THE INVENTION

1. Field of the Invention

The present invention relates to method of manufacturing an orthodontic appliance, especially an orthodontic bracket or a buccal tube, consisting, in full or in part, of a plastic material which exhibits a water absorption capacity.

2. Description of Related Art

Brackets of this kind, which may be made from a polyarylether ketone or from a polyoxymethylene, for example, are disclosed in DE 196 18 364 A1. Such materials are characterised by higher. strength and lower notch sensitivity, compared with polycarbonates, which are also commonly used for brackets, but unlike the latter they are capable of absorbing water. In use of the brackets this water-absorbing property causes the brackets to absorb saliva, water and, together with it, sugar, polysaccharides, minerals and micro-organisms in the mouth. This not only may lead to unsightly discoloration of the brackets, but’ also has the result to encourage plaque to build up more rapidly on such brackets, which plaque is then much more difficult to remove than from brackets made from other materials, Brackets consisting of plastic materials which exhibits a water absorption capacity therefore tend—even if the teeth are cleaned frequently—to build up plaque which is detrimental to oral hygiene and presents a culture medium for cariogenic bacteria.

### SUMMARY OF THE INVENTION

Now, it is an object of the present invention to open up a way how to counteract the detrimental effects of plaque formation on brackets and other orthodontic appliances made from plastic materials which exhibit a water absorption capacity.

This object is achieved by an orthodontic appliance having the features defined in Claim 1. Advantageous further developments of the invention are the subject-matter of the sub-claims.

Although the problems of accelerated plaque formation and reduced cleaning properties encountered with brackets and other orthodontic appliances made from plastic materials which exhibit a water absorption capacity are due especially to their water-absorbing property, the present invention does not propose the obvious solution to remove the water-absorbing property, which could be achieved, for example, by the application of a sealing enamel. Instead, the invention transforms the originally disadvantage property, namely the water absorption capacity, into an advantage by utilising the water-absorbing property for depositing in the orthodontic appliance a water-soluble additive that restrains the formation of plaque. Infiltration of such an additive is preferably effected by impregnation of the finished moulded orthodontic appliance. During impregnation, the plaque-restraining additive is distributed in the water-absorbing orthodontic appliance, especially in its pores and micropores, in all areas of the structure of the plastic material where water could otherwise be infiltrated due to the originally existing water absorption capacity of the material. In this connection, the term micropores is understood as describing pores that can no longer be discerned with a person's bare eyes. As no high temperatures are encountered in the human mouth, the additive will not be driven out in that environment. Eating and drinking, however, may give rise to exchange processes in the water-absorbing plastic material. These do not, however, render the invention ineffective because on the one hand such exchange processes develop slowly, and because on the other hand an orthodontic appliance that has been soaked and saturated in an impregnation process presents a reservoir of the plaque-restraining additive which will migrate from the depth of the orthodontic appliance back to its surface when the surface of the orthodontic appliance or any areas close to the orthodontic appliance surface start to get depleted of the additive. Deposition of bacteria-induced plaque on the surface is, thus, counteracted for a long time. Further, it has been found to be of advantage that the additive restraining the formation of plaque is simultaneously suited to prevent, or at least restrain, unsightly discoloration of the orthodontic appliance.

It is not part of the invention to process the additive jointly with the plastic material in forming the orthodontic appliance by injection moulding. Such processing would lead to a considerable portion of the additive getting tightly enclosed in the plastic material which would render it ineffective as regards its function to prevent the formation of plaque. Moreover, the additive embedded by the injection moulding process would change the properties of the plastic material. If, however, the additive is infiltrated subsequently by impregnation it can deploy much greater effectiveness and will in addition reduce the porosity which in effect is in part responsible for the formation of plaque.

It is a particular advantage of the invention that the formation of plaque is restrained especially in pores or micropores of the plastic material as the additive develops its effect in those areas as well, so that the formation of plaque is prevented also in places where plaque cannot normally be removed by cleaning.

In addition, the discharge of an antibacterial additive from the orthodontic appliances due to exchange processes occurring in the mouth has favourable effects on oral hygiene generally. This is so because the saliva then always contains a slight concentration of the antibacterial additive which is effective not only on the orthodontic appliance but practically everywhere in the mouth. This provides the advantage that building-up of plaque is counteracted not only on the orthodontic appliance but also on the teeth.

According to an advantageous further development of the invention, the additive has a wetting effect and/or has a wetting agent added to it. This feature on the one hand provides the advantage that the additive can be deposited even in small and smallest pores of an orthodontic appliance according to the invention, which can be achieved for example by impregnation or by spraying upon the orthodontic appliance an aqueous solution that contains the additive. Now, a wetting additive or a wetting agent added to it not only provides the advantage that the orthodontic appliance can be loaded with a higher quantity of the additive, but also has the effect that later in the mouth the additive—will wet the surfaces of the orthodontic appliance with a fine constantly renewing film, which is especially effective in counteracting the building up of plaque. Another advantage of that feature is seen in the fact that the additive being discharged into the cavity of the mouth will also wet the surface of the teeth and may thereby protect them from plaque as well.

Another advantageous further development of the invention provides that the additive contains xylitol. Though Xylitol has been known before as an additive in toothpaste or mouthwash, where it is used because of its sweetening effect in order to give the toothpaste or the mouthwash, respectively, an agreeable taste, it has now surprisingly been found that brackets or other orthodontic appliances, that have been impregnated with xylitol, show considerably reduced formation of plaque. According to the invention xylitol can therefore be deposited in the orthodontic appliances even as single additive. Xylitol is washed out from orthodontic appliances according to the invention only in quantities so small that its sweet taste, which would be undesirable in view of its continuous presence, will remain unnoticed. Further, a substance well suited to restrain the formation of plaque is tin fluoride, especially if combined with a wetting agent, for which purpose aminofluorides, especially octadecyl trimethylenediamine-N,N,N′-tris(2-ethanol)-dihydrofluoride or 9-octadecenylamine-hydrofluoride are particularly well suited.

Also suited as antibacterial additive are derivatives of hexamethylene bisguanide, especially chlorohexidine digluconate.

The plaque-restraining additives may be added individually or in combination with other plaque-restraining substances and/or with one or more wetting agents.

Suitable plastic materials for the production of an orthodontic appliance according to the invention are, especially, polyoximethylene homopolymer or a polyarylether ketone, which distinguish themselves by especially favourable mechanical properties and an attractive colour. An orthodontic appliance according to the invention may of course also be produced from a plurality of plastic materials, as has been disclosed in DE 196 18 364 A1. In this case at least one of the materials shall exhibit a water-absorbing property. The invention is also suited for orthodontic appliances consisting of plastic materials having only slight water-absorbing capacity. Although such an orthodontic appliance cannot absorb as much plaque-restraining substances as an orthodontic appliance with higher water-absorbing capacity, this disadvantage is balanced out by the fact that orthodontic appliances of that kind are less prone to building up plaque from the very beginning.

Orthodontic appliances in which the invention can be used with advantage are, above all, brackets and buccal tubes, but also components of other appliances made from plastic materials having a water absorption capacity and serving to correct malformations of teeth and jaws, such as components of Herbst joints and other appliances for displacement of the lower jaw.

Orthodontic appliances according to the invention are produced by initially moulding the shape of the orthodontic appliance from the plastic material, especially by injection moulding. The orthodontic appliance is then impregnated with the additive in dissolved state, and dried. Due to the fact that the additive is soluble in water, the impregnation process is carried out, preferably, using an aqueous solution of the additive. This does not, however, exclude dissolution of the additive in a vehicle different from water, for example in an alcohol, and impregnation of the orthodontic appliance with such a non-aqueous solution.

Prior to the impregnation process, any volatile components that may be contained in the moulded orthodontic appliance as a result of the production process, are driven out. Such components may consist, for example, of non-polymerised formaldehyde. For driving out the volatile components, the orthodontic appliances may be heated and/or subjected to an extraction process in a vacuum chamber. Or, alternatively, the orthodontic appliances may be immersed in hot water, especially in water having a temperature of approximately 70° Celsius, and left to soak therein for a period of several hours up to several days. Thereafter, the orthodontic appliances are conveniently centrifuged in a heated centrifuge, where the largest part of the water is removed, and are then placed in a vacuum chamber where all volatile substances will gassify practically without any residue, and will be extracted. Impregnation of the orthodontic appliances is preferably effected by leaving the orthodontic appliances to soak under the action of heat, for a period of several hours up to several days, in an aqueous solution of the additive used to restrain the formation of plaque. Preferably, a saturated solution of the additive is used, An especially suitable temperature of the solution to be used for impregnation is 50° Celsius. After impregnation, the orthodontic appliances are dried, for example again in the heated centrifuge.

### BRIEF DESCRIPTION OF THE DRAWINGS

Further details and advantages of the invention will become apparent from an exemplary embodiment of the invention described with reference to the attached drawing in which:

FIG. 1 shows a cross-section of an embodiment of the bracket according to the invention.

### DETAILED DESCRIPTION OF THE DRAWINGS

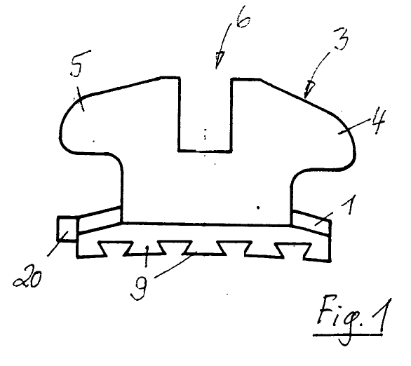

The embodiment illustrated in FIG. 1 comprises a pad 1 which is provided with undercut projections 9 that may get interlocked with a bonding agent for the purpose of achieving good adhesion on a tooth. Provided on the upper face of the pad I is a two-winged receiving and guiding element 3 with a slot 6, into which an arch wire can be inserted, passing through the wings 4 and 5. An extension 20 provided on the pad 1 serves as a marking that facilitates the correct alignment of the bracket on a tooth.

The illustrated bracket consists for example of a polyoximethylene homopolymer. As an initial step, the non-polymerised aldehydes are driven out from the bracket. This may be achieved by heating the brackets and/or by leaving the bracket to soak in water and/or by extraction. The process results in a free porosity of the bracket. Thereafter, the bracket is dried, as required, and is impregnated with a water soluble antibacterial additive for which purpose the bracket is immersed in an aqueous solution of the additive where it is left to soak for several hours or a few days. Especially well suited for this purpose is a solution of tin fluoride which contains an aminofluoride as a wetting agent and which in addition may be enriched with xylitol. Upon completion of the impregnation process, the bracket is dried at room temperature or at a higher temperature. The bracket can be used in the same way as conventional brackets.

1-23. (canceled)

24. Method of manufacturing an orthodontic appliance from plastic material comprising the steps of
selecting a plastic material having a water absorption capacity,
molding the orthodontic appliance from the plastic material by injection molding,
driving out volatile components from the orthodontic appliance,
impregnating the orthodontic appliance with a water-soluble additive that restrains the formation of plaque by leaving it to soak in an aqueous solution of the additive,
drying the orthodontic appliance.

25. The method according to claim 24 in which the plastic material is selected to be polyoximethylene or a polyarylether ketone.

26. The method according to claim 24 in which the plastic material is selected to provide the orthodontic appliance with pores or micro-pores.

27. The method according to claim 24 in which prior to impregnating the orthodontic appliance the volatile components are driven out by leaving the orthodontic appliance to soak in water that has been heated up to a temperature above room temperature, and that the orthodontic appliance is then dried.

28. The method according to claim 24 in which for driving out the volatile substances, the orthodontic appliance is exposed to a subatmospheric pressure.

28. The method according to claim 28 in which the orthodontic appliance is heated prior or while being exposed to subatmospheric pressure.

29. The method according to claim 29 in which the orthodontic appliance is heated up to 40° C. to 60° C.

30. The method according to claim 24 in which the aqueous solution, in which the orthodontic appliance is impregnated, is heated.

31. The method according to claim 30 in which the solution is heated to 40° C. to 60° C.

32. The method according to claim 24 in which the additive is selected to have a wetting property.

33. The method according to claim 24 in which the additive is selected to include a wetting agent.

34. The method according to claim 33 in which the additive includes an aminofluoride as a wetting agent.

35. The method according to claim 34 in which the wetting agent is selected to be N′-octadecyl trimethylenediamine-N,N,N′-tris(2-ethanol)-dihydrofuoride or 9-octadecenylamine-hydrofluoride.

36. The method according to claim 24 in which the additive includes or is tin fluoride.

37. The method according to claim 36 in which the additive includes tin fluoride in combination with an aminofluoride.

38. The method according to claim 24 in which the additive is or includes xylitol.

39. The method according to claim 24 in which the additive is or includes a derivate of hexamethylene bisguanide

40. The method according to claim 39 in which the additive is or includes chlorohexidine digluconate.

41. The method according to claim 24 in which a bracket or buccal tube is molded.
